(19) United States
(12) Patent Application Publication
(10) Pub. No.: US 2014/0165839 A1
(43) Pub. Date: Jun. 19, 2014

(54) Extended Life Panel Filter

(71) Applicant: LaMonte A. Crabtree, LaGrange, KY (US)

(72) Inventor: LaMonte A. Crabtree, LaGrange, KY (US)

(73) Assignee: Clarcor Air Filtration Products, Inc., Jeffersonville, IN (US)

(21) Appl. No.: 14/098,258

(22) Filed: Dec. 5, 2013

Related U.S. Application Data
(60) Provisional application No. 61/736,658, filed on Dec. 13, 2012.

(51) Int. Cl. B01D 46/52; B03C 3/34

(52) U.S. Cl. CPC B01D 46/522; B03C 3/34
USPC 96/15; 55/497; 55/499

(57) ABSTRACT

A panel filter is provided. The panel filter can have extended life by virtue of more filter media packed into a panel filter in a way that maintains open flow structure and with filter media selection that does not cause undue restriction.

### CROSS-REFERENCE TO RELATED PATENT APPLICATIONS

This patent application claims the benefit of U.S. Provisional Patent Application No. 61/736,658, filed Dec. 13, 2012, the entire teachings and disclosure of which are incorporated herein by reference thereto.

### FIELD OF THE INVENTION

This invention generally relates to air filters, and more particularly relates to panel air filters that are used, for example, in Heating, Ventilation and Air Conditioning (HVAC) systems.

### BACKGROUND OF THE INVENTION

Paneled air filters are commonly used for filtering air in forced air systems such as Heating, Ventilation and Air Conditioning systems, commonly known as HVAC. Panel air filters generally comprise a rectangular filter media pack supported by a support structure in a rectangular configuration such as being surrounded and supported by a die cut paper board panel frame or by strips, bands, scrims, screens or the like.

One common type of filter media used in panel filters is pleated filter media that includes a plurality of peaks and valleys. Various prior art implementations are known to support pleated filter media so that the panel filters may withstand air pressure during operation. Such prior art includes U.S. Pat. No. 6,709,480 to Sundet et al.; U.S. Pat. No. 5,782,944 to Justice; and U.S. Patent Publication Number 2007/0294988 assigned to the present assignee, the entire disclosures of which are hereby incorporated by reference thereto.

Generally, in panel filter implementations for HVAC, there are competing interests involved. On the one hand, a panel filter must provide sufficient dust holding capacity without plugging prematurely to provide adequate filter life span. Additionally, the filter has to provide a suitable particle capture efficiency by removing sufficiently small particles such as dust and allergens from the air that are known to be entrained in such forced air ventilation systems. Often, a Minimum Efficiency Reporting Value (MERV) value of at least 11 or greater is desired for such forced air applications.

On the other hand, it is desirable not to restrict the flow of air and thereby provide for an open filter structure that allows for easy air flow through the pleated panel filter. The primary reason is that plugging is determined by the pressure drop that is experienced across the filter. Additionally, restricting airflow makes it harder for an HVAC system to deliver hot, cold and/or ventilated air resulting in energy loss. One test for determining the service life of a filter is evaluating dust holding capacity of the filter when the final resistance or pressure drop across the filter reaches one inch in water gauge pressure at a face velocity of 295 feet per minute. Thus, while a restrictive media is desired so as to enable adequate particle capture efficiency, a more open media is desired for air flow characteristics and to prevent premature clogging.

As a result, prior art panel filters have often been a compromise between these two competing interests. In many applications, a service life interval of 90 days for normal usage parameters is often suggested for air filters, which correlates to the pressure drop service life interval may also be determined, in part, by the dust holding capacity needed for 90 days in a typical building, that is experienced at the one inch water gauge in pressure drop.

To provide for a sufficiently open air flow media, prior art panel filters have employed a pleat spacing that is conventionally 3.5 pleats per inch, or less, so as to allow for sufficient air flow gaps between pleats to withstand the high air flow. Oftentimes, many prior art filters have included between 2 and 3.5 pleats per inch. Applicant believes total amount of media of the prior art is typically less than five square feet of filter media contained per square foot, per ⅞ inch depth of media defined by normal 1″ or 2″ fitting filters (i.e. defined by a square foot of the panel filter and measured per ⅞ inch of pleat depth).

### BRIEF SUMMARY OF THE INVENTION

Various embodiments of the present invention provide for an extended life panel filter or a panel filter that is able to load with substantially more dust with an expanded dust holding capacity. In some embodiments, it is provided by packing more filter media in an organized fashion into a panel of filter media while at the same time, maintaining sufficiently open structure to avoid air flow restriction. Media can be selected appropriately as discussed herein. With this, an extended life service is provided with panel filters according to various embodiments of the present invention.

According to one aspect of the present invention, a panel filter comprises a panel of filter media that is pleated. The panel has pleats with pleat tips spanning a first span. The panel spans a second span transverse to the pleat tips. The pleats define a pleat depth normal to the first and second span. In accordance with this aspect, more than five square feet of filter media is contained per square foot defined by the first and second spans and measured per ⅞ inch depth of pleat depth. The panel filter also includes a support structure supporting the filter media in a rectangular configuration.

For typical HVAC panel filter applications, the pleat depth is less than 3 inches such as a 1″ fitting or 2″ fitting filter element and, typically, the widths of the first and second spans each span between 12 and 30 inches (with any fractions being rounded up to the next highest number for this parameter).

Preferably, even more than 5 square feet of filter media is contained for the volume envelope measurement defined above. Preferably more than 6 square feet of filter media is provided, even more preferred more than 7 square feet of filter media and most preferably, more than 7.5 square feet of filter media is provided.

The panel filter media can provide a dust holding capacity of greater than 25 grams of Ashrae #2 test dust per square foot of the panel filter (measured again by the two lateral spans), measured at a face velocity of 295 feet per minute and upon reaching a resistance of 1″ water gauge pressure. The dust holding capacity may preferably be greater than 30 grams and in certain preferred embodiments greater than 35 grams.

Further, the panel filter may have at least a MERV 12 rating or higher, but it will typically at least be MERV 11 rating for many embodiments.

Preferably, the filter media comprises polymeric fibers with a basis weight of between 65 and 80 grams per square media, with a media thickness of between 0.3 and 0.7 millimeters thereby providing for high loft. The filter media may be an electret with polymeric fibers containing fluorine with an electrostatic charge to provide the filter media with at least a MERV 12 or higher rating (without such fluorine in charge, the filter media may otherwise comprise between a MERV 7-11 rating).

In various embodiments to provide for sufficiently open structure between pleats, the polymeric fibers of filter media may be heat set and embossed with spacer supports between pleat flanks such as integrally laid lines of adhesive spacer supports extending around pleat tips and connecting with adjacent pleat tips.

Another aspect of the present invention may relate to a method of extending a replacement service interval of an HVAC system employing a panel filter according to the above aspect and any of the additional noted other features that may be employed above. The method may comprise providing the panel filter in the rectangular configuration and installing the panel filter into an HVAC system to filter air flowing along the HVAC system.

According to this method, the service interval may be increased by at least 1.5 times relative to an original panel filter that was installed in the HVAC system and more preferably, doubling the service interval time. Therefore, for example, a 90 day service interval may be doubled to 180 days or at least may be increased to 135 days while achieving the same dust loading capabilities without increasing restriction.

Another different inventive aspect of the present invention is directed toward a panel filter with embossments and adhesive spacer supports to provide for more open flow type filter media. A panel filter, according to this aspect, comprises a panel filter media that is pleated wherein the panel has pleats with pleat tips spanning a first span. The panel filter spans a second span transverse to the pleat tips. The pleats define a pleat depth normal to the first and second spans with the filter media being pleated to a depth of less than 3 inches. The pleats have embossments extending between pleat tips (e.g. formed into and along pleat flanks) and adhesive spacer supports extending around pleat tips and along the embossments and connecting with adjacent pleat tips. The panel filter further can include additional support structure supporting the filter media in a rectangular configuration.

Yet another different inventive aspect pertains to a panel filter with an increased pleat density that is more than 3.5 pleats per inch along the second span, which is transverse to the pleat tips. This panel filter includes a panel filter media that is pleated wherein the panel filter has pleats with pleat tips spanning a first span in the panel spanning a second span transverse to the pleat tips. The pleats define a pleat depth normal to the first and second span with the pleated media comprising more than 3.5 pleats per inch along the second span. The support structure is provided for supporting the filter media in a rectangular configuration.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective and partially cut-away view of a panel filter element according to a first embodiment of the present invention;

FIG. 2 is a frontal view of a rectangular filter media pack that may itself be used as a panel filter or, more preferably, that may be framed such as being employed in the panel filter of FIG. 1;

FIG. 3 is a partly schematic cross section of FIG. 1 taken through one of the adhesive beads of adhesive spacers; shown without embossments or flattened pleat tips shown taken about line 3-3 (See FIG. 4A-4C for further detail).

FIG. 4 is a partly schematic cross section view of the embossed and adhesively spaced filter media viewed from either of the inlet and outlet sides, which views are the same, and taken through the pleat tips parallel to one of the inlet and outlet faces.

FIG. 4A is a cross section of the filter media pack that may be taken about line 4A of FIG. 3;

FIGS. 4B and 4C are cross sections of filter media that may be taken about lines 4B-4B and 4C-4C respectively of FIG. 4A.

FIG. 5 is an exploded assembly view of the panel shown in FIG. 1;

FIG. 6 is a graph of particle size removal efficiency according to an example employing the embodiment of FIG. 1;

FIG. 7 is a graph detailing clean resistance vs. airflow according to an example employing the embodiment of FIG. 1;

FIG. 8 is a graph comparing filter resistance with dust loading according to an example employing the embodiment of FIG. 1;

FIG. 9 is an isometric view of an alternative embodiment of a panel filter element according to an embodiment of the present invention shown for use with a reusable filter housing in accordance with an embodiment of the present invention; and

FIG. 10 is an enlarged view of a portion of FIG. 9.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

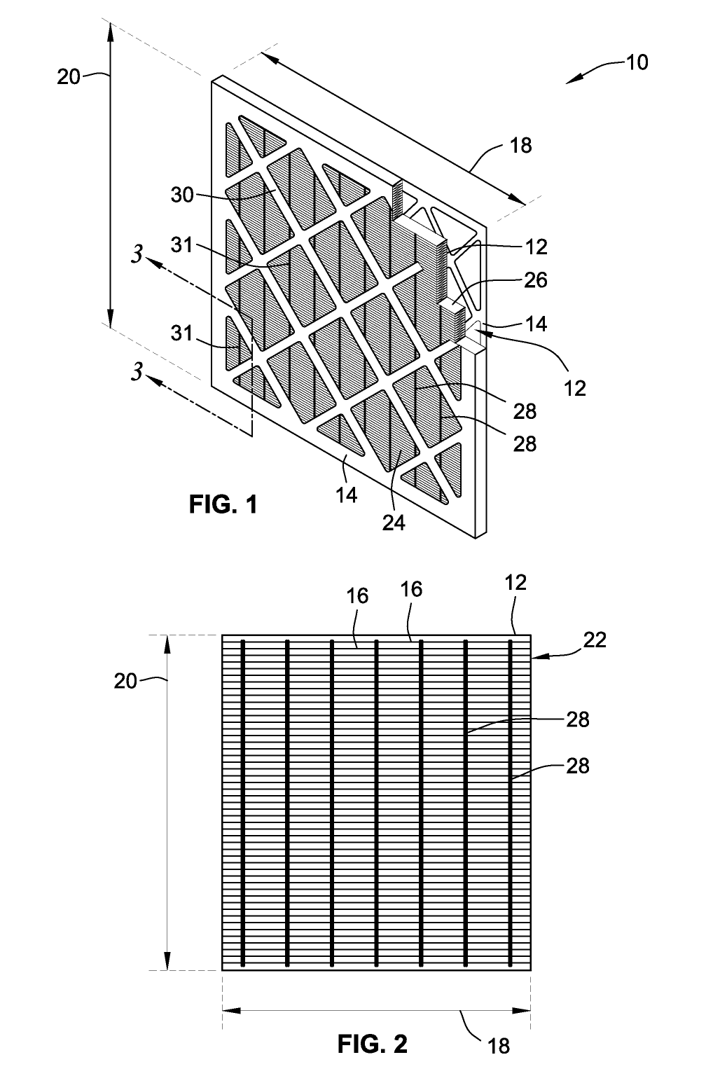

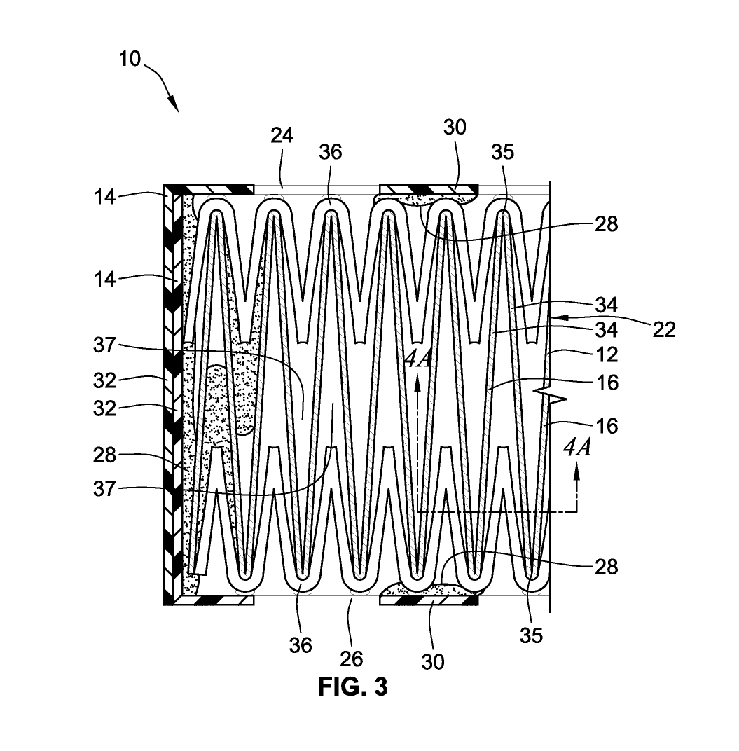

FIGS. 1 and 2 illustrate embodiments of a panel filter 10 of the present invention. The panel filter 10 generally includes a pleated filter media 12 that is arranged in a rectangular card-like structure and that is maintained in that rectangular card-like configuration by a suitable support structure such as one of preferably two die cut paperboard frames 14, as shown.

The pleated filter media 12 is formed from a relatively thin porous material such as an entanglement of polymeric fibers and/or cellulose or glass fibers that permits air to readily pass through, but intercepts solid particles such as dust, lint and the like. The panel filter 10 illustrated is particularly suited for Heating, Ventilation and Air Conditioning (HVAC) systems that employ forced air such as used in homes, offices and other such buildings. The filter media is folded into multiple pleats 16 to provide sets of pleat tips 35 on each side (both inlet and outlet sides) of the panel filter 10.

As shown, a high pleat density is obtained with the full face of pleat flanks exposed during use (not blinded) with structural support discussed herein with a pleat density greater than the typical 3.5 pleats per inch used in typical HVAC applications. Further, greater than 5 square feet of filter media may then be contained per square foot defined by the respective spans of the panel filter and measured per ⅞″ depth of the pleats.

As for size, for typical HVAC applications, the panel filter 100 may span a first lateral span 18 of between 12 and 30 inches and a second lateral span 20 transverse to the first span that is also between about 12 and 30 inches. Pleat depth can be measured normal to these spans 18 and 20.

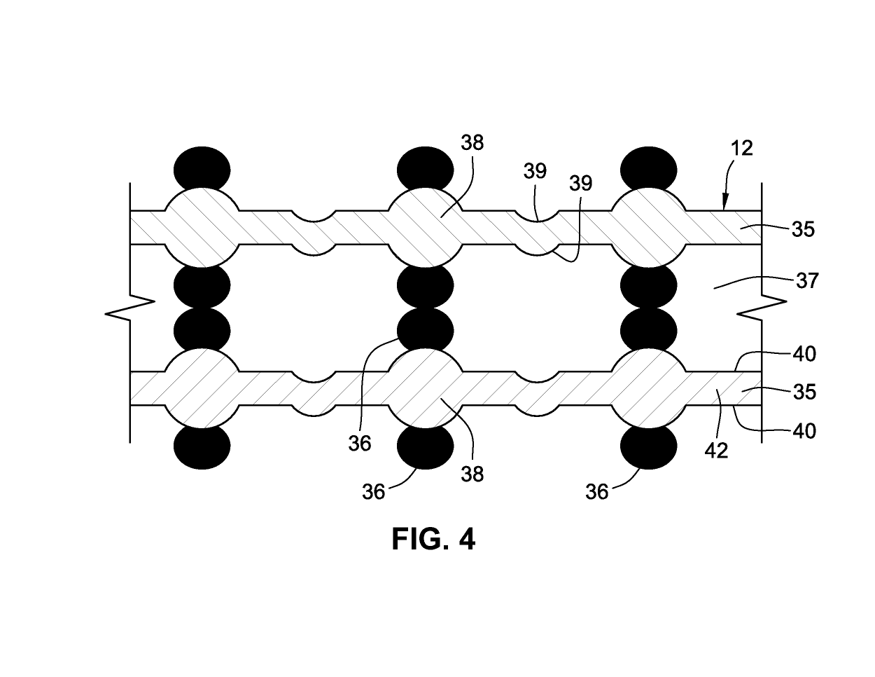

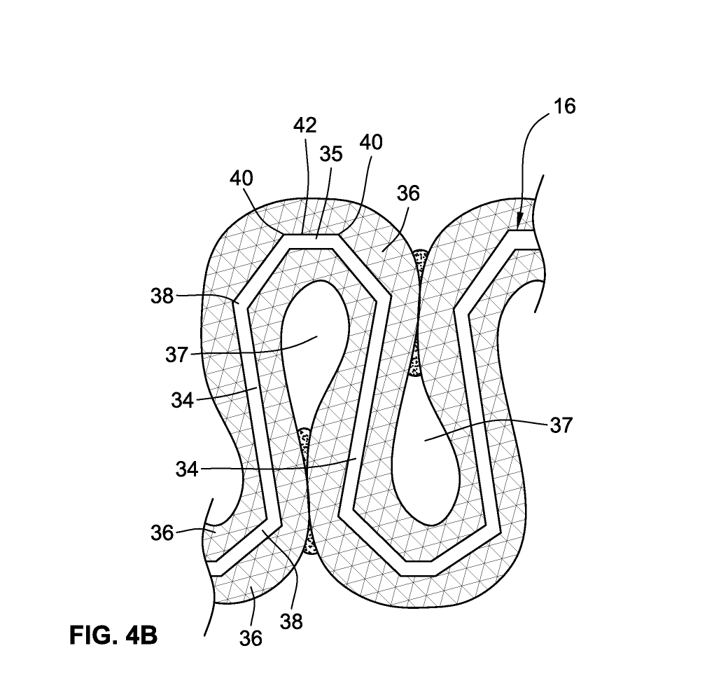

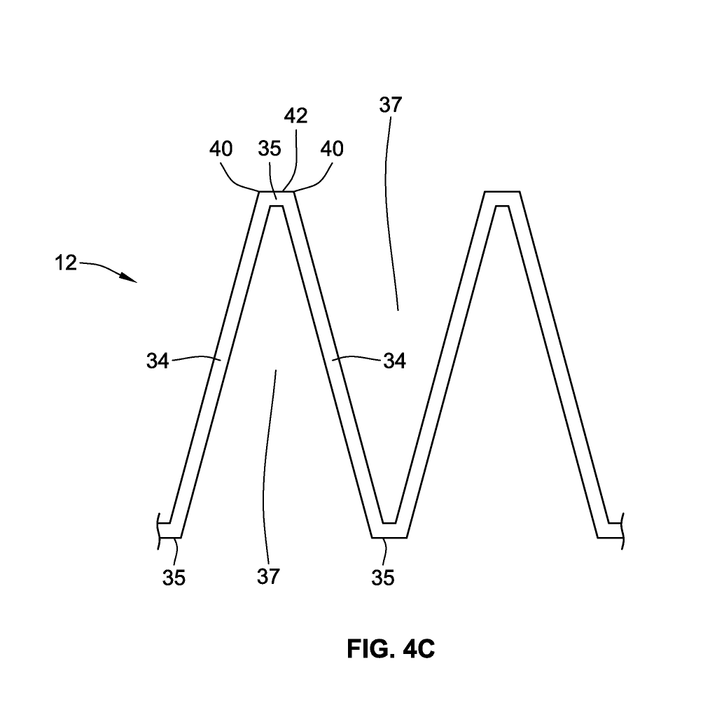

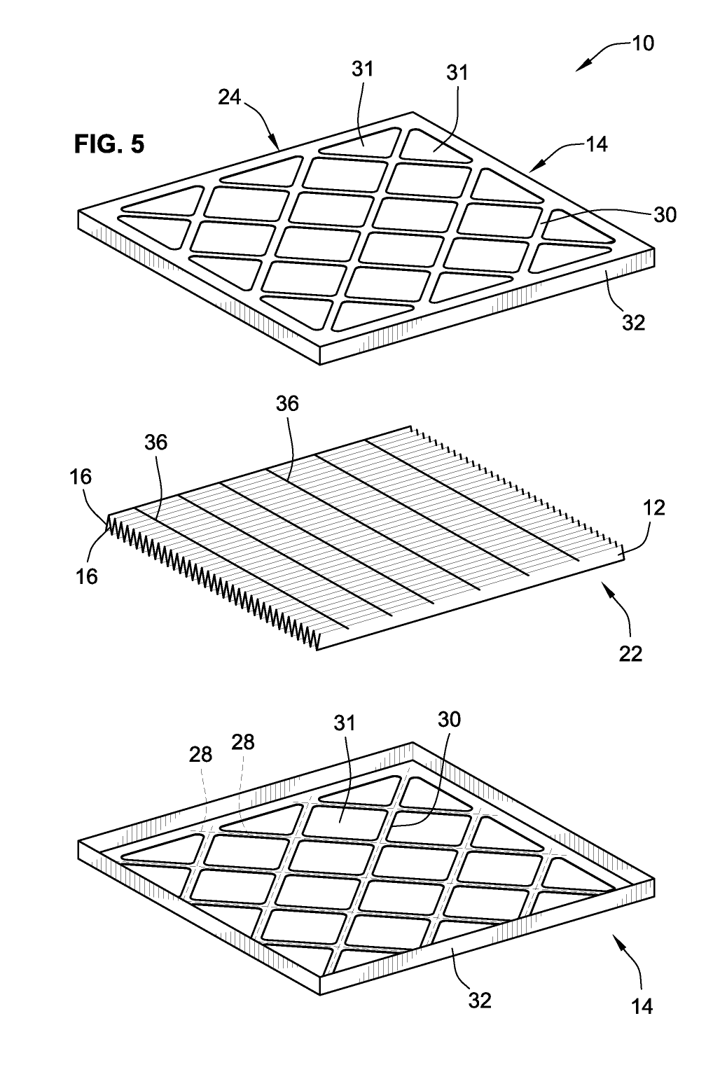

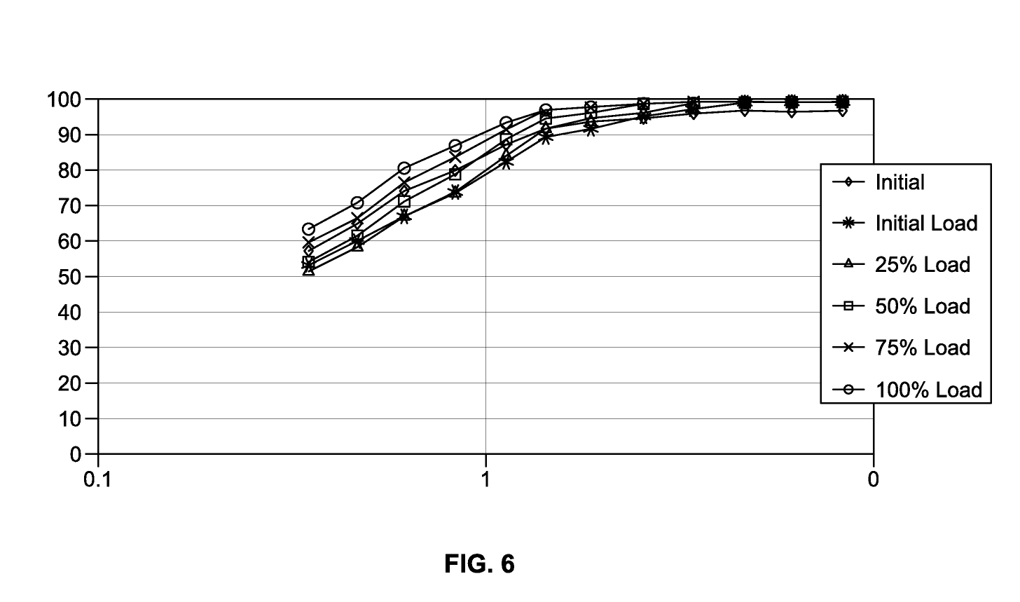

In the embodiment shown in FIG. 1 and also demonstrated by FIGS. 3 and 5, each of the inlet side 24 and outlet side 26 of the pleated filter media 12 are supported by a rectangular paperboard frame 14, which may be a one piece die cut frame. Alternatively, border frames, edge band frames or the like, may be used. The frames 14 are telescopically interfit with each other with each frame covering one of the inlet side and outlet side.

With this configuration and with adhesive 28 laminated to the inner surfaces of each of the frames 14, it can be seen that the filter media 12 is supported and protected with integral webbing 30 that extends transverse across a rectangular border 32 of each frame 14. The adhesive 28 may be applied with a roller coater prior to the assembly shown in FIG. 5 such as when the die cut frame 14 is folded flat prior to being assembled into the semi-boxlike configuration shown in FIG. 5. With this configuration, the pleat tips 35 along both the inlet side 24 and outlet side 26 are adhesively secured to the integral webbing 30 of the frame. Further, adhesive secures and seals between the outer rectangular periphery of the pleated filter media 12 and the inner periphery of the rectangular border 32 provided by the frames 14.

The integral webbing 30 may be formed when multiple holes 31 are cut out from the filter frame material during a frame die cutting process. The integral webbing 30 may have generally diagonal shaped holes 31 with each hole providing between 6 and 20 square inches area opening. As a result, sufficient airflow is achieved and no restriction due to the integral webbing is realized or such restriction is otherwise de minimis.

To achieve an organized filter media configuration with high pleat density without unduly restricting airflow, the embodiment employ adhesive spacer beads 36, which are laid down by an adhesive bead line applied upon both the inlet side 24 and outlet side 26 of the pleated filter media during manufacture. The beads 36, serve to provide structural support to the pleated filter media to hold the structure into a rectangular filter media pack 22.

Generally, the adhesive spacer beads 36 are continuous strips of adhesive that are laid as the media is being run in the direction of the second span in a continuous manner over each of the inlet side 24 and outlet side 26 to form the adhesive spacer beads 36 on opposing sides of the filter media, thereby forming the filter media pack 22. As can be seen, the adhesive spacer beads 36 therefore extend up and over pleat tips and down into pleat valleys along the pleat flanks at least partially into the V-shaped channels formed between adjacent pleat flanks and in some embodiments may reach all the way to the bottom of such V-shaped channels as the adhesive spacer beads are laid continuously.

The adhesive spacer beads may be laid down in parallel lines at a spacing (relative to the next adjacent adhesive bead) between ½ and 4 inches and in some embodiments, more preferably between 1 and 2 inches. This provides sufficient structural support to maintain the pleat shape and V-shaped channels 37 with sufficient open volume to provide airflow without undue restriction. The adhesive spacer beads 36 also afford support to prevent the pleats from collapsing and contacting each other to prevent blinding off the filter media during operation. For example, V-shaped channels 37 do not deform or collapse very much during use, which maintains airflow into the channels to move through filter media of pleat flanks. As a result, much more of the surface area of the pleated filter media 12 is exposed for full filtration and dust loading purposes. Further, the configuration allows for dust cake accumulation without prematurely filling or blocking the V-shaped channels 37 with this pleat density and support structure configuration.

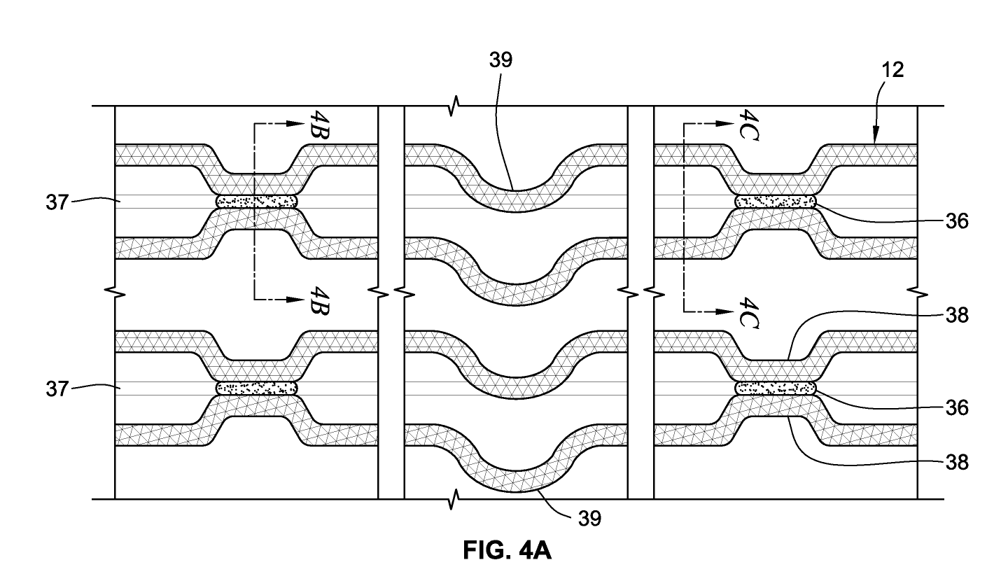

To assist in the spacing and structural integrity, various embossments 38 are provided to widen the pleat flanks at the select areas where the adhesive spacer beads 36 are laid down. This can be seen, for example, in FIG. 4 whereby embossments are formed such as by heat setting and/or compression forming into the pleat flanks 34 every one to 2 inches (or between ½ and four inches in some other embodiments depending upon the spacing of the adhesive spacer beads 36). Embossments 38 provided a shorter span needed for the adhesive to bridge across the V-shaped channels 37 between adjacent pleats. Additionally, additional embossments 39 may be interspaced between the adhesive spacer bead embossments 38 as illustrated also at a similar spacing of the adhesive spacer bead embossments 38. These other embossments 39 do not receive a glue bead, but provide for additional structural support and also prevent flat surface-to-surface contact between filter media along the pleat flanks 34 in response to airflow forces during use.

Referring to FIG. 2, it can be seen that this may provide a filter media pack 22 that has employed the adhesive spacer beads 36 and embossments 39, 39 such that the filter media pack 22 is ready to be framed via frames 14 for use to create the panel filter shown in FIG. 1. Alternatively, the adhesive spacer beads 36 may provide the support structure to maintain the pack in the rectangular configuration and as such, itself may form a panel filter with this support structure in an embodiment.

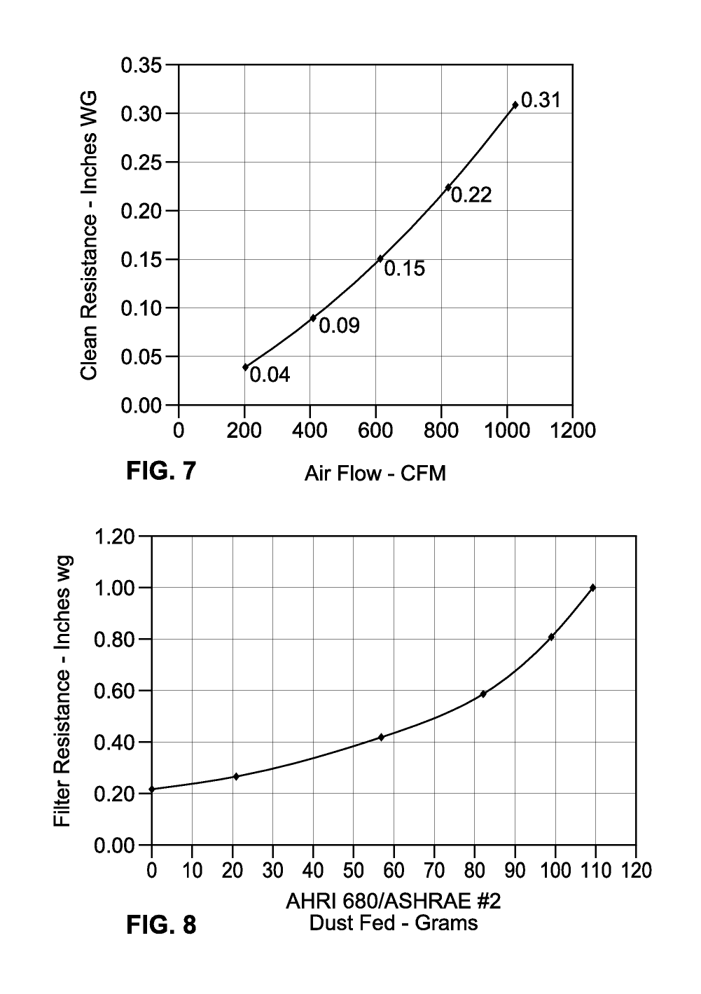

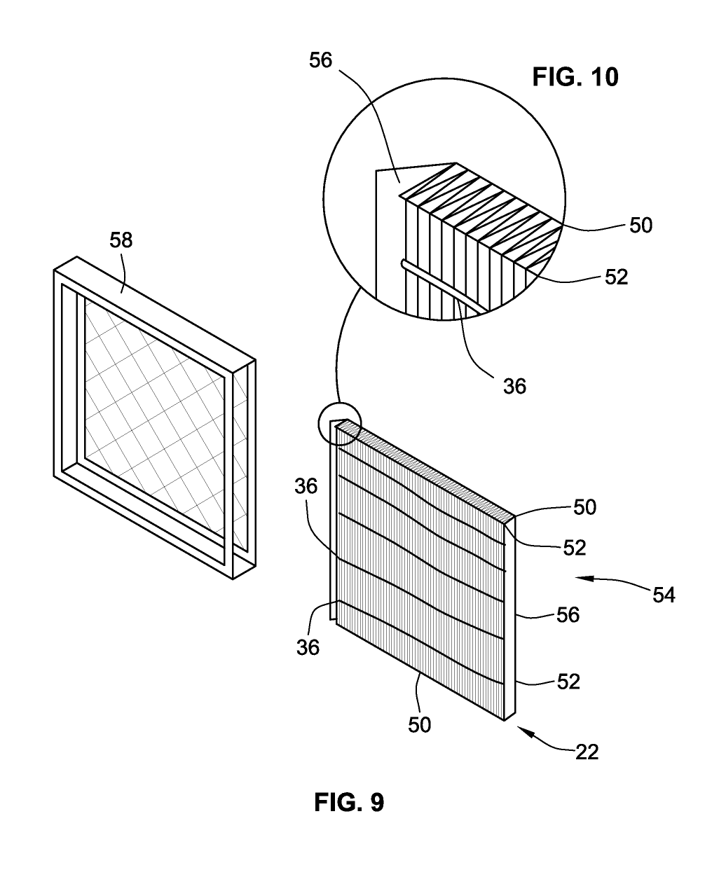

However, it should be noted that preferably, additional structure such as an outer peripheral frame structure such as planar edge bands 50 may be laminated across the zig-zagging end faces 52 at opposing ends of the filter media pack 22 as shown in FIGS. 9 and 10 to provide yet another embodiment of a panel filter 54. The edge bands 50 may comprise planar strips of filter media, which may then be adhesively secured to the end faces at two opposed ends of the filter media pack 22 or can be heat set and heat welded to the ends to provide sufficiently stiff structure. The final pleat flank at either the other two end faces of panel filter 54 may be free and may be used as compression end pleats in a suitable housing such as filter housing 58, which is shown as a rectangular frame having a side entry opening and track to slidably receive the panel filter 54. The end pleat flank 56 on the two free sides (not constrained by edge bands 50) can be free to be compressed or otherwise trapped by filter housing 58 to thereby better ensure that airflow is directed through the filter media pack 22.

As evident in embodiments above, to provide a support structure for supporting the media in a rectangular configuration, various frames, scrims, bands and the like may be used in addition to, or in the alternative to those disclosed according to the embodiments described above. Support structures in various other embodiments of the present application may be used such as disclosed in U.S. Patent Publication Number 2012/0167535 entitled, “Self Supported Pleated Panel Filter With Frayed Edges”; U.S. Patent Publication Number 2010/0269468 entitled, “Panel Filter”; U.S. 2010/0269467 entitled, “Panel Filter”; U.S. Pat. No. 7,537,632 entitled, “Panel Filter With Frame”; U.S. Patent Publication Number 2005/224170 entitled, “Method and System for Making Filters”; and U.S. Pat. No. 5,782,944. Each of these patents are incorporated by reference in their entireties for support structures and panel filter details may be used as alternatives or an addition to those in embodiments discussed specifically herein.

As demonstrated in embodiments above, to better facilitate for structural integrity and high air flow while at the same time packing more media into a tighter configuration with increased pleat density, some embodiments may include pleat supports and spacers between adjacent pleat flanks 34. For filter elements configured to operate in high-flow-rate environments, spacers, such as plastic finger spacers or hot-melt adhesives spaced at regular intervals, may be placed at regular intervals along the pleated filter media to add structural rigidity and prevent deformation of the media. In addition to being pleated with heat setting of the pleats, the filter media may also be embossed to add structural rigidity, to further increase surface area, and to increase amount of media that can be manipulated into a volume for the panel filter 10. A method of embossed filter media is described in U.S. Pat. No. 6,685,833. U.S. Pat. No. 5,290,447, U.S. Pat. No. 5,804,014 and DE 19755466 A1 also describe methods of embossing that, in some embodiments, may be applied to the composite filter media of the present invention as an addition or alternative. Each of these patents are incorporated by reference in their entireties, as these or other pleating and embossing technologies may be used.

For example, integrally formed embossments 38 (grooves, folds or wrinkles extending between pleat tips 35 and between inlet and outlet faces) formed into the filter media and adhesive spacer beads 36 are illustrated on the filter media of filter media pack 22 as shown in FIGS. 1-5. Various numbers and arrangements of embossments can be provided. The adhesive beads are on adjacent pleat tips and extend along pleat sides and attach to each other as shown. This provides consistent pleat spacing and structural integrity to the pleated filter pack. Adjacent pleat tips may be spaced between ¼ and ¾ centimeter to compact a substantial amount of filter media into the envelope while at the same time keeping an open flow structure to accommodate high air flow capacity. Also, the peat tips may be flattened with two creased edges 40 and a flat 42 therebetween as schematically illustrated in FIG. 35. Flats 42 may between 0.5-2.5 millimeters wide in some embodiments.

To better facilitate for structural integrity and high air flow, some preferred embodiments may include additional pleat supports and spacers between adjacent pleat flanks 34. For filter elements configured to operate in high-flow-rate environments, spacers, such as plastic finger spacers or hot-melt adhesives spaced at regular intervals, may be placed at regular intervals along the pleated filter media to add structural rigidity and prevent deformation of the media. In addition to being pleated with heat setting of the pleats (e.g. with bicomponent filter media with high melt and low melt fibers and/or high melt and low melt components in fibers), the filter media may also be embossed to add structural rigidity, to further increase surface area, and to increase amount of media that can be manipulated into a volume for panel filter. Any of these aforementioned structures may be employed as support structure to maintain a rectangular configuration as an alternative to or in addition to frames (e.g. die cut frames and/or edge banding).

### Filter Medias

In embodiments, the filter media may comprise non-woven polymeric and preferably polyolefin fibers a basis weight of between 65 and 80 grams per square meter and a media thickness of between 0.3 and 0.7 millimeters, thereby providing for high loft. The high loft provides a high dust loading capability and air permeability. Preferably, the polymeric fibers contain fluorine and provide an electrostatic charge to provide the filter media with at least a MERV 12 or higher rating, wherein the filter media without the fluorine and electrostatic charge comprises between a MERV 7-11 rating. The electret can allow for a more open less restrictive media such that restriction is not necessarily increased with pleat density. An air permeability of between 150 and 250 cfm at 0.5 inch WG pressure may be provided flat sheet media testing. To provide for heat setting of pleats, the filter media base preferably includes a component polymeric structure including a high melt polymer and a low melt polymer

For example, the filter media may be charged to an electret with surface fluorination, which may be according to U.S. Pat. No. 6,419,871, assigned to Transweb, LLC. Other fluorination methods may include the addition of fluorochemicals according to U.S. Pat. Nos. 5,411,576 and 5,472,481 to Jones et al and/or U.S. Pat. No. 5,908,598 to Rousseau et al. Each of the patents referenced in this paragraph are thus incorporated by reference in their entirety.

One embodiment uses filter media grade KC621L XZPN, which is commercially available from Transweb LLC, of Vineland, N.J., with reported properties in the table below:

TABLE 1

| | | | TSI @ 32.0 NaCl | | A.P. |
|---|---|---|---|---|---|
| | Wght. | Bulk | Res. | Pen. | (cfm@0.5″ |
| sample # | (gms/m²) | (mm) | (mm/H²O) | (%) | H²O) |

TL-12-06-11-50 (29.5″)

| | | | | | |
|---|---|---|---|---|---|
| 1 | 73.2 | 0.56 | 0.6 | 15.6 | 178.0 |
| 2 | 71.3 | 0.56 | 0.5 | 14.9 | 201.0 |
| 3 | 74.8 | 0.58 | 0.4 | 17.1 | 170.0 |

TL-12-06-11-51 (22.0″)

| | | | | | |
|---|---|---|---|---|---|
| 1 | 71.6 | 0.51 | 0.5 | 17.2 | 177.0 |
| 2 | 70.0 | 0.56 | 0.7 | 16.0 | 171.0 |
| AVERAGE | 72.2 | 0.55 | 0.5 | 16.2 | 179.4 |
| STDEV | 1.86 | 0.03 | 0.11 | 1.0 | 12.58 |
| MINIMUM | 70.0 | 0.51 | 0.4 | 14.9 | 170.0 |
| MAXIMUM | 74.8 | 0.58 | 0.7 | 17.2 | 201.0 |

### Panel Filter Sizes & Media Pack Amounts & Pleat Spacing

Generally in the panel filter art, the sizes are relatively standard. A common size is a 20 inch×20 inch×1 inch filter. This means the filter will fit an envelope of that size but is typically a bit smaller to allow for easy installation. For example, the actual depth of the filter frame may be 15/16 of an inch and the pleat depth about ⅞ inch for a 1 inch fitting filter. Similarly, the pleat depth for a 2 inch fitting filter may be 1 and ¾ inch. Therefore, useful measures are made using these depths.

For most panel filters, the pleat depth is less than 3 inches (typically either 2 inches or 1 inch), with lateral width spans each spanning between 12 inches and 30 inches (fractions being rounded up in this instance considering that the panel filter element need only fit an envelope that size). With the increased media packed into the panel filter, for example the amount of filter media per square foot for the most common sized filters may be set forth in the following table for various embodiments:

TABLE 2

| | | SQFT of |
|---|---|---|
| | | media |
| Size | Description | per filter |
| 16 × 20 × 1 | PuroAire (E-Pleat) 16 × 20 | 16.8518 |
| | 6 pk | |
| 16 × 25 × 1 | PuroAire (E-Pleat) 16 × 25 | 21.1073 |
| | 6 pk | |
| 20 × 20 × 1 | PuroAire (E-Pleat) 20 × 20 | 21.1487 |
| | 6 pk | |
| 20 × 25 × 1 | PuroAire (E-Pleat) 20 × 25 | 26.4893 |
| | 6 pk | |
| 14 × 20 × 1 | PuroAire (E-Pleat) 14 × 20 | 14.9875 |
| | 6 pk | |
| 14 × 25 × 1 | PuroAire (E-Pleat) 14 × 25 | 18.7344 |
| | 6 pk | |
| 14 × 24 × 1 | PuroAire (E-Pleat) 14 × 24 | 17.5354 |
| | 6 pk | |
| 12 × 12 × 1 | PuroAire (E-Pleat) 12 × 12 | 7.6904 |
| | 6 pk | |

As is evident from the above and with the configuration afforded to the panel filter with various embodiments of the present invention whereby the filter media is formed into a compacted pleat pack, more than 5 square feet of filter media is contained per square foot defined by the width spans and measured per ⅞ inch depth of pleat depth. More preferably, more than 6 or 7 square feet of filter media is contained per square foot defined by the panel filter width spans and measured per ⅞ inch depth of pleat depth, with some preferred embodiments more than 7.5 square feet of filter media is contained per square foot defined by the first and second spans and measured per ⅞ inch depth of pleat depth. By way of example, the 20×20×1 covers a lateral area of 400 square inches or 2.778 square feet and therefore about 7.61 square feet of filter media can be pleated and contained per square foot defined by the panel filter width spans and measured per ⅞ inch depth of pleat depth.

For a 2 inch depth fitting filter, the later width span sizes may be the same, but it will be appreciated that the gross amount of square feet of media per filter is about double as the pleat depth has about doubled. However, the amount of filter media contained per square foot defined by the width spans and measured per ⅞ inch depth of pleat depth is comparable to the 1 inch fitting filter elements. As such also for two inch elements, the preferred ranges mentioned in the preceding paragraph and herein throughout are also generally applicable to 2 inch fitting filter elements, unless otherwise stated or self-evident to one of ordinary skill in the art.

To provide the increased density of filter media, one of the ways to accomplish the same is by increasing pleat density to a tighter density with decreasing pleat depth. In many embodiments, the pleated media comprises more than 3.5 pleats per inch along the second span, and more preferably, the pleated media comprises at least 4 pleats per inch along the second span and even more preferably, pleated media comprises at least 4.5 pleats per inch along the second span or more. Pleat density can be measured at pleat tips (e.g. counting the number of pleat tips per inch).

To avoid undue restriction, the embossments and/or the adhesive spacers serve to provide support to the pleats to ensure open areas for air to enter between pleats.

A relatively high loft media such as described herein can be selected in many embodiments to achieve reduced restriction and higher air flow.

At the same time, an electret filter media, that is a media with an electrostatic charge, may be used to provide higher efficiency for particle capture and retention, despite the more open media.

### Examples & Comparisons

A KC621LXZPN filter media of Transweb, LLC was heat set embossed with adhesive bead spaces and arranged in filter cartridge in a 20×20×1 configuration (with about 21 square feet of media) according to an embodiment of FIG. 1 described above and then subjected to testing against other non-embossed medias for panel filters. The pleat spacing was 4.5 pleats-5.0 pleats per inch.

Results demonstrating a high particle capture efficiency (MERV rating) with a high dust holding capacity are demonstrated in the following table.

TABLE 3

| | | | | | | Dust | | (Round |
|---|---|---|---|---|---|---|---|---|
| | Efficiency | | | | | Holding | E's Mult/ | +−50) Rated |
| | 0.3-1.0 | 1.0-3.0 | 3.0-10.0 | | | Capacity | 100 | Performance |
| Media | micron | micron | micron | MERV | Resistance | (grams) | Rating | Factor |
| KC621LXZPN emboss | 63.0 | 90.0 | 97.0 | 13 | 0.22 | 108 | 5500 | 5500 |
| KC621LXZPN emboss | 63.0 | 90.0 | 96.0 | 13 | 0.22 | 110 | 5443 | 5450 |
| KC621LXZPN emboss | 66.0 | 91.0 | 97.0 | 13 | 0.22 | 105 | 5826 | 5850 |
| | | Avg. | 97.0 | 13 | | | 5590 | 5600 |
| KC621LXZPN | 76.0 | 91.0 | 98.0 | 14 | | | 6778 | 6800 |
| KC621LXZPN | | | | | | | 0 | 0 |
| KC621LXZPN | | | | | | | 0 | 0 |
| | | Avg. | 98.0 | 14 | | | 6778 | 6800 |
| TW4.0MBPPXZPNLY30 | 58.0 | 85.0 | 94.0 | 12 | .18 | 9 | 4634 | 4650 |
| TW4.0MBPPXZPNLY30 | 58.0 | 84.0 | 94.0 | 12 | .19 | 9 | 4580 | 4600 |
| TW4.0MBPPXZPNLY30 | 59.0 | 85.0 | 93.0 | 12 | .19 | 9 | 4664 | 4650 |
| | | Avg. | 94.0 | 12 | | | 4626 | 4650 |
| TF58A | 30.0 | 77.0 | 87.0 | 11 | .21 | 34 | 2010 | 2000 |
| TF58A | 31.0 | 75.0 | 86.0 | 11 | .21 | 35 | 2000 | 2000 |
| TF58A | 29.0 | 78.0 | 87.0 | 11 | .20 | 33 | 1968 | 1950 |
| | | Avg. | 87 | 11 | | | 1992 | 2000 |
| KC353H | 14.0 | 45.0 | 40.0 | 6 | .18 | 13 | 252 | 250 |
| KC353H | 14.0 | 44.0 | 40.0 | 6 | .19 | 12 | 246 | 250 |
| KC353H | 11.0 | 45.0 | 40.0 | 6 | .17 | 13 | 198 | 250 |
| | | Avg. | 40 | 6 | | | 232 | 250 |

Comparisons were made with a 20×20×1 panel filter made with embossed KC621LXZPN filter media of Transweb, LLC (Purofied E-Plt RPG 5450) with other comparative 20×20×1 filters. Results are shown in the following table. From this, the average of dust holding capacity of 48 grams of test dust while Purofied E-Plt RPG 5450 would have an average dust holding capacity of 108 grams. From this, the normal service life expectancy and interval of 90 days, could be extended to 180 days.

| | AHRI | | DUST | 3rd Party | |
|---|---|---|---|---|---|
| | 680/ASHRAE#2 | | HOLD | Test 3-10 | |
| Filter | Test Dust | Resist | CAPICITY | Microns E3 | MERV |
| Comparative Filter A | ASHRAE II test | 0.32 | 45.00 | | 11 |
| | dust loading | | | | |
| Comparative Filter B | ASHRAE II test | 0.21 | 77.00 | | 12 |
| | dust loading | | | | |
| Comparative Filter F | ASHRAE II test | 0.32 | 33.00 | | 13 |
| | dust loading | | | | |
| Comparative Filter G | ASHRAE II test | 0.21 | 36.00 | | 12 |
| | dust loading | | | | |
| Purofied E-Plt RPF | ASHRAE II test | 0.22 | 108.00 | 97% | 13 |
| 5450 | dust loading | | | | |
| Purofied E-Plt RPF | ASHRAE II test | 0.22 | 110.00 | 96% | 13 |
| 5450 | dust loading | | | | |
| Purofied E-Plt RPF | ASHRAE II test | 0.22 | 105.00 | 97% | 13 |
| 5450 | dust loading | | | | |

### Testing Standards

For the tests and standards discussed herein, the following can be used: ASHRAE #2 test dust obtained from Powder Technology, Inc. This test dust consists of 93.5% ISO 12103-1 A2 Fine plus 6.5% cotton linters. This dust is specified for use in AHRI Standard 680-2009 “Performance Rating of Residential Air Filter Equipment”. Test conditions include air temperature between 68 and 73 degrees Fahrenheit, relative humidity of between 46-50%, test aerosol of KCL, barometric pressure (in. HG) of between 29.32-29.38, particle counter being an S3I System. Face velocity for testing was 295 FPM (819 cfm air flow for a 20×20×1), with dust holding capacity being determined when a pressure drop and resistance of 1.00 WG pressure was measured.

Generally the protocols followed are a full 52.2-2007 ASHRAE Test, MERV 5-16 procedure with AHRI Test Dust.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A panel filter, comprising:
a panel of filter media that is pleated, wherein the panel has pleats with pleat tips spanning a first span and the panel spanning a second span transverse to the pleat tips, the pleats defining a pleat depth normal to the first and second spans, wherein more than 5 square feet of filter media is contained per square foot defined by the first and second spans and measured per ⅞ inch depth of pleat depth; and
a support structure supporting the filter media in a rectangular configuration.

2. The panel filter of claim 1, wherein the pleat depth is less than 3 inches, and wherein the first and second spans each span between 12 inches and 30 inches.

3. The panel filter of claim 2, wherein the pleat depth is about 1 and ¾ inches for a 2 inch fitting filter element.

4. The panel filter of claim 2, wherein the pleat depth is about ⅞ inch to provide for a 1 inch fitting filter element.

5. The panel filter of claim 1, wherein more than 6 square feet of filter media is contained per square foot defined by the first and second spans and measured per ⅞ inch depth of pleat depth.

6. The panel filter of claim 1, wherein more than 7 square feet of filter media is contained per square foot defined by the first and second spans and measured per ⅞ inch depth of pleat depth.

7. The panel filter of claim 1, wherein more than 7.5 square feet of filter media is contained per square foot defined by the first and second spans and measured per ⅞ inch depth of pleat depth.

8. The panel filter of claim 1, wherein the panel of filter media provides a dust holding capacity of greater than 25 grams of AHRI680/ASHRAE #2 test dust per square foot of the panel filter, measured at a face velocity of 295 feet per minute and upon reaching a resistance of 1 inch water gauge pressure.

9. The panel filter of claim 1, wherein the panel of filter media provides a dust holding capacity of greater than 30 grams of AHRI680/ASHRAE #2 test dust per square foot of the panel filter, measured at a face velocity of 295 feet per minute and a resistance of 1 inch water gauge pressure, wherein the panel filter has at least a MERV 11 rating or higher.

10. The panel filter of claim 1, wherein the panel of filter media provides a dust holding capacity of greater than 35 grams of AHRI680/ASHRAE #2 test dust per square foot of the panel filter, measured at a face velocity of 295 feet per minute and upon reaching a resistance of 1 inch water gauge pressure, and wherein the panel filter has at least a MERV 12 rating or higher.

11. The panel filter of claim 8, wherein the filter media comprises polymeric fibers a basis weight of between 65 and 80 grams per square meter and a media thickness of between 0.3 and 0.7 millimeters, thereby providing for high loft, the polymeric fibers containing fluorine with an electrostatic charge to provide the filter media with at least a MERV 12 or higher rating, wherein the filter media that without the fluorine and electrostatic charge comprises between a MERV 7-11 rating.

12. The panel filter of claim 1, wherein the pleated media comprises more than 3.5 pleats per inch along the second span.

13. The panel filter of claim 1, wherein the pleated media comprises at least 4 pleats per inch along the second span or more.

14. The panel filter of claim 1, wherein the pleated media comprises at least 4.5 pleats per inch along the second span or more.

15. The panel filter of claim 12, wherein the filter media is pleated to a depth of less than 3 inches and comprises synthetic polymeric fibers that are heat-set and embossed and have spacer supports between pleat flanks to provide structural integrity sufficient for an air flow face velocity of at least 295 feet per minute without collapsing.

16. The panel filter of claim 13, filter media is pleated to a depth of less than 3 inches, the pleats being having embossments extending between pleat tips and adhesive spacer supports extending around pleat tips and along the embossments and connecting with adjacent pleat tips.

17. The panel filter of claim 16, wherein the pleat tips are flattened with flattened pleat tips extending between 0.5 and 2.5 millimeters along the second span.

18. The panel filter of claim 1, wherein the support structure comprises a rectangular frame with a rectangular frame border and integral webbing extending across the rectangular frame border, the rectangular frame bonded to the filter media with adhesive, wherein the integral webbing is bonded to the pleat tips on a first side with adhesive.

19. The panel filter of claim 18, further comprising a second rectangular frame that includes the rectangular frame border and integral webbing extending across the rectangular frame border, the second rectangular frame bonded to the filter media with adhesive, wherein the integral webbing is bonded to the pleat tips on a second side opposite said first side with adhesive.

20. The panel filter of claim 1, wherein the support structure comprises a rectangular frame including edge banding traversing at least partially or completely around a perimeter of the filter media.

21. The panel filter of claim 1, wherein the support structure comprises at least one of webs, bands and strips of at least one of adhesive, plastic, synthetic or cellulose based material extending across pleat tips of the filter media.

22. The panel filter of claim 1, wherein the panel of filter media includes pleat flanks extending between pleat tips, further comprising adhesive spacers around the pleat tips at at least one of an inlet face and an outlet face, the adhesive spacers adhesively securing adjacent pleat tips.

23. The panel filter of claim 1, further comprising embossments integrally formed into the pleat flanks.

24. A method of extending a replacement service interval of an HVAC system employing the panel filter of claim 1, comprising:
providing the panel filter in the rectangular configuration;
installing a panel filter into the HVAC system to filter air flowing along the HVAC system.

25. The method of claim 22, further comprising increasing the service interval by at least 1.5 times relative to an original panel filter that was installed in the HVAC system.

26. The method of claim 22, further comprising increasing the service interval by at least 2 times relative to an original panel filter that was installed in the HVAC system.

27. A panel filter, comprising:
a panel of filter media that is pleated, wherein the panel has pleats with pleat tips spanning a first span and the panel spanning a second spantransverse to the pleat tips, the pleats defining a pleat depth normal to the first and second spans, filter media is pleated to a depth of less than 3 inches, the pleats being having embossments extending between pleat tips and adhesive spacer supports extending around pleat tips and along the embossments and connecting with adjacent pleat tips; and
a support structure supporting the filter media in a rectangular configuration.

28. The panel filter of claim 27, wherein the pleat tips are flattened with flattened pleat tips extending between 0.5 and 2.5 millimeters along the second span.

29. The panel filter of claim 27, wherein the support structure includes a rectangular frame that includes a rectangular frame border and integral webbing extending across the rectangular frame border, the rectangular frame bonded to the pleated filter media with adhesive, wherein the integral webbing is bonded to the pleat tips on a first side with adhesive.

30. The panel filter of claim 27, wherein the panel of filter media provides a dust holding capacity of greater than 30 grams of AHRI680/ASHRAE #2 test dust per square foot of the panel filter, measured at a face velocity of 295 feet per minute and a resistance of 1 inch water gauge pressure, wherein the panel filter has at least a MERV 11 rating or higher, wherein the filter media comprises polymeric fibers a basis weight of between 65 and 80 grams per square meter and a media thickness of between 0.3 and 0.7 millimeters, thereby providing for high loft, the polymeric fibers containing fluorine with an electrostatic charge to provide the filter media with at least a MERV 12 or higher rating, wherein the filter media that without the fluorine and electrostatic charge comprises between a MERV 7-11 rating.

31. The panel filter of claim 27, wherein the pleated media comprises at least 4 pleats per inch along the second span or more.

32. The panel filter of claim 27, wherein the pleated media comprises at least 4.5 pleats per inch along the second span or more.

33. A panel filter, comprising:
a panel of filter media that is pleated, wherein the panel has pleats with pleat tips spanning a first span and the panel spanning a second spantransverse to the pleat tips, the pleats defining a pleat depth normal to the first and second spans, wherein the pleated media comprises more than 3.5 pleats per inch along the second span; and
a support structure supporting the filter media in a rectangular configuration.

34. The panel filter of claim 33, wherein the pleated media comprises at least 4 pleats per inch along the second span or more.

35. The panel filter of claim 33, wherein the pleated media comprises at least 4.5 pleats per inch along the second span or more.

36. The panel filter of claim 33, wherein the panel of filter media provides a dust holding capacity of greater than 30 grams of AHRI680/ASHRAE #2 test dust per square foot of the panel filter, measured at a face velocity of 295 feet per minute and a resistance of 1 inch water gauge pressure, wherein the panel filter has at least a MERV 11 rating or higher, wherein the filter media comprises polymeric fibers a basis weight of between 65 and 80 grams per square meter and a media thickness of between 0.3 and 0.7 millimeters, thereby providing for high loft, the polymeric fibers containing fluorine with an electrostatic charge to provide the filter media with at least a MERV 12 or higher rating, wherein the filter media that without the fluorine and electrostatic charge comprises between a MERV 7-11 rating.
